(19) United States
(12) Patent Application Publication
(10) Pub. No.: US 2017/0309197 A1
(43) Pub. Date: Oct. 26, 2017

(54) SYSTEM FOR AUTOMOTIVE QUALITY OF LIFE PROGRAM

(71) Applicant: Cedars-Sinai Medical Center, Los Angeles, CA (US)

(72) Inventor: Brennan Spiegel, Los Angeles, CA (US)

(73) Assignee: Cedars-Sinai Medical Center, Los Angeles, CA (US)

(21) Appl. No.: 15/523,610

(22) PCT Filed: Nov. 10, 2015
(86) PCT No.: PCT/US2015/059991

§ 371 Date: May 1, 2017

Related U.S. Application Data
(60) Provisional application No. 62/078,864, filed on Nov. 12, 2014.

(51) Int. Cl. G09B 7/06; G09B 5/06

(52) U.S. Cl. CPC G09B 7/06; G09B 5/06

(57) ABSTRACT

A method and system to gather and evaluate quality of life data is disclosed. A controller is provided in a vehicle to ask a series of questions relating to quality of life to a person in the vehicle via a speaker system. The controller receives responses to the questions orally via a microphone. The controller translates the responses into quality of life data. The controller analyzes the data to evaluate the quality of life of the person. The data is stored and may be used for further evaluation of quality of life for the person.

### PRIORITY INFORMATION

The application claims priority from U.S. Provisional Application No. 62/078,864, filed Nov. 12, 2014. That application is incorporated by reference in its entirety.

### TECHNICAL FIELD

The disclosure relates generally to systems and methods for self-evaluation. In particular, the disclosure relates to a system for use in an automobile for evaluating quality of life of a driver.

### BACKGROUND

In general, human behavior is determined by two objectives: to seek pleasure and to avoid pain. The success of meeting these goals may be determined by measuring quality of life (“QoL”). Quality of life refers to the degree of physical, emotional, and social wellbeing achieved in everyday life. When someone is physically well, emotionally satisfied, and socially supported, that individual has a high quality of life. In contrast, when someone experiences physical pain, emotional distress, or poor social support, that individual has a low quality of life.

People are universally interested in improving their quality of life. Moreover, with the emergence of the “quantified self” movement, a social trend where people meticulously monitor their physical and emotional well-being, there is unprecedented interest in tracking QoL scores. For example, the National Institutes of Health (NIH) developed the Patient Reported Outcomes Measurement Information System (PROMIS), which is a set of computer-administered questionnaires that measure QoL across the range of biopsych-social experiences. PROMIS allows users to score their QoL, compare their results to the general U.S. population, track their QoL over time, and plan interventions to improve QoL

However, monitoring and addressing QoL with programs like PROMIS requires concerted effort and dedicated focus. In today's busy world, it is difficult for people to find time to contemplate their QoL, track QoL, or proactively improve QoL by running programs such as PROMIS. In short, there is a disconnection between the importance of measuring QoL and the limited time to engage in this activity. The mismatch is itself a symptom of poor quality of life, evidence that life has gotten out of control. People need a quiet environment, focused attention, and extended periods of time to monitor and improve their quality of life.

There are few opportunities for people to effectively evaluate their quality of life. However, there are activities that are performed during day-to-day life that offer time for self-contemplation. For example, drivers of vehicles have extended periods of unoccupied time in a sheltered and generally quiet space that is not presently used to improve quality of life.

Thus, there is a need for an automotive-based solution for evaluating quality of life. There is a further need for a system that utilizes extended periods of unoccupied time in driving to gather data to evaluate and improve quality of life.

### SUMMARY

One example is a system for performing quality of life assessment of a person in a vehicle. The system includes an audio system for broadcasting audio messages and a microphone for vocal inputs from the person. A controller is coupled to the audio system and the microphone. The controller is operative to ask a series of questions relating to quality of life to the driver using the audio system. The controller receives responses to the questions via the microphone. The controller translates the responses into quality of life data. The controller evaluates the quality of life of the person based on the responses to the questions.

Another example is a method of gathering quality of life data for a person in a vehicle. Verbal questions relating to quality of life to the person in the vehicle are provided. Responses to the questions from the person are received via a microphone. The responses to the questions are translated into quality of life data. A score is determined based on the quality of life data for the person. A score relating to quality of life is sent to a storage device.

Additional aspects of the invention will be apparent to those of ordinary skill in the art in view of the detailed description of various embodiments, which is made with reference to the drawings, a brief description of which is provided below.

### BRIEF DESCRIPTION OF FIGURES

Exemplary embodiments are illustrated in referenced figures. It is intended that the embodiments and figures disclosed herein are to be considered illustrative rather than restrictive.

FIG. 1 is a block diagram of a vehicle-based system that allows data collection relating to quality of life of a driver;

FIG. 2 is a flow diagram of the process of the system in FIG. 1 to provide data collection relating to quality of life and provide suggested evaluation and feedback;

FIGS. 3A-3H are diagrams of different question groups presented by the self-evaluation system in FIG. 1 for determining quality of life data;

FIGS. 4A and 4B are images of example user interfaces on handheld devices for displaying quality of life data from the system in FIG. 1; and

FIG. 5 is a flow diagram for the process followed by the controller in the vehicle in FIG. 1 to obtain quality of life data.

### DETAILED DESCRIPTION

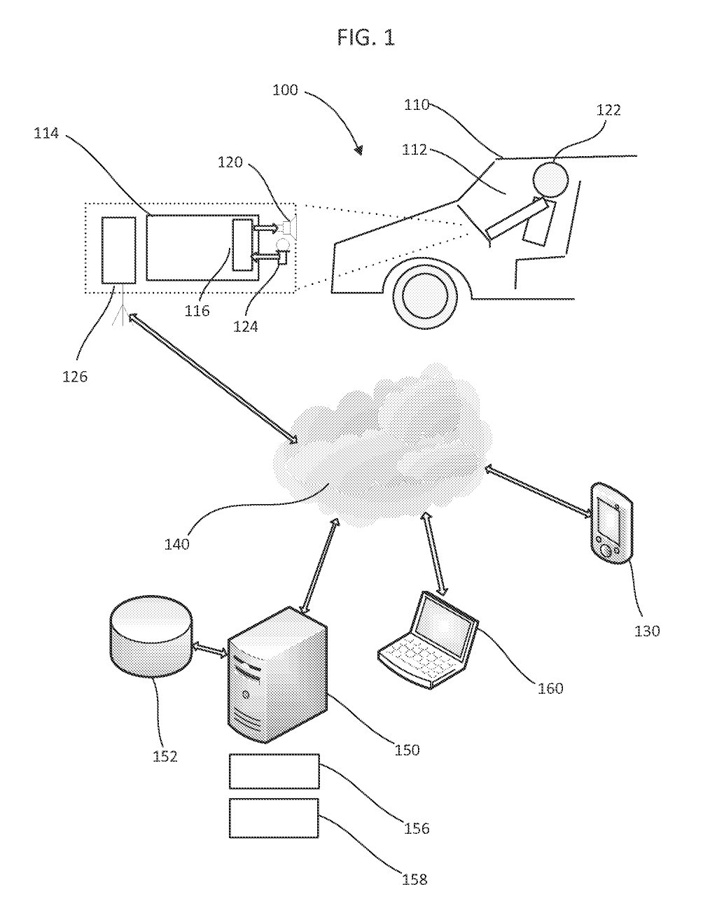

FIG. 1 is a block diagram of the quality of life evaluation system 100 centered around a vehicle such as an automobile 110. The automobile 110 includes a passenger compartment 112 that includes a quality of life controller 114. The quality of life controller 114 includes a user interface module 116, which includes translating questions to audio form and receiving audio responses and translating the responses to data. The quality of life interface module 116 may be included in the dashboard or console of the automobile 110. The quality of life controller 114 uses the interface module 116 coupled to a speaker system 120 to communicate vocally to a driver 122. Of course other occupants of the vehicle may also use the system 100 for evaluation of their quality of life. The quality of life controller 114 is coupled via the interface module 116 to a microphone 124 that may accept voice inputs and commands from the driver or other vehicle occupants. The speaker system 120 and the microphone 124 may be part of the automotive audio system. The quality of life controller 114 is also coupled to a data transceiver 126, which communicates data to a network external to the automobile 110.

The system 100 also includes a handheld device 130 that may be in communication with a wide area network such as an Internet 140. The handheld device 130 may be any mobile devices, such as a cell phone, tablet, PDA, or smartphone. A server 150 is coupled to the Internet 140 and a central database 152. The server 150 includes an evaluation module 156 and a toolbox module 158. Each of the modules 156 and 158 include applications relating to analysis and evaluation of received quality of life data from users such as the driver of the automobile 110. Of course, the server 150 may download certain evaluation and toolbox applications to devices via the Internet 140 such as the handheld device 130 or the controller 114. The applications in the evaluation module 156 and the toolbox module 158 may either be executed by the server 150 and accessed by devices via the Internet 140 or pushed out for installation on devices via the Internet 140. The central database 152 stores quality of life data generated from the controller 114 and other devices that may acquire quality of life data as will be explained below. The handheld device 130 receives data from the database 152 and the server 150 relating to quality of life for the driver of the automobile 110 and as was explained above, allows data display to the driver outside of the vehicle from other devices. Another computing device such as a personal computer 160 may also receive the evaluation data from the central database.

The automobile provides a unique opportunity to transform a mundane and often stressful activity, driving, into an opportunity for personalized quality of life measurement and coaching. Drivers have extended periods of unoccupied time in a sheltered and generally quiet space—an optimal environment to measure, track, and improve quality of life.

Thus, the system 100 takes advantage of the time a driver spends in an automobile to deliver a unique solution for personalized quality of life coaching. By administering psychometrically valid and reliable quality of life questionnaires via voice command, the system 100 measures the driver's quality of life, analyzes the results, and delivers tailored coaching to improve quality of life both in the car and through an accompanying mobile device application. The sections, below, describe the process for measuring, tracking, interpreting, and managing quality of life of the driver of the automobile 110.

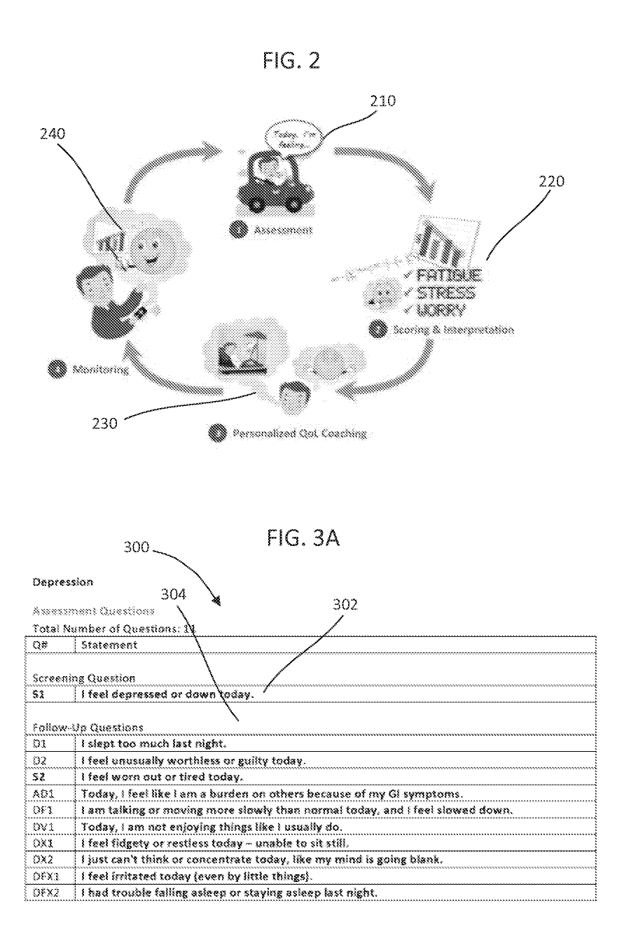

FIG. 2 is a block diagram showing the process performed by the quality of life controller 114 and the system 100 in FIG. 1. The personalized automotive quality of life coaching program operated by the controller 114 and the server 150 operates in a self-learning cycle that first assesses the quality of life of the driver 210, scores the quality of life 220, interprets the quality of life scores, and provides tailored coaching in the form of applications from the toolbox module 156 to address drop in quality of life indicated by dropping quality of life scores 230. The system 100 then monitors the quality of life 240. The cycle returns to the beginning to obtain updated assessment, track quality of life longitudinally, and provide detailed quality of life coaching instructions. A mobile and web-based application on the handheld device 130 or another computing device 160 in FIG. 1 creates data visualizations and reports for use outside of the automobile 110.

The disclosed process begins with administration of psychometrically valid quality of life questionnaires through a voice command system run by the controller 114 through the interface module 116. Upon activation by the driver, the controller 114 greets the driver via a vocal prompt sent through the interface module 116 to the speaker system 120. The vocal prompt provides a menu of options, including: (a) momentary assessment (“how are you feeling now?”); (b) daily check-in (“how are you feeling today?”); and (c) weekly check-in (“how have you felt during the past week?”) verbally. The driver selects the program of interest via vocal commands received by the microphone 124 and begins the questionnaire.

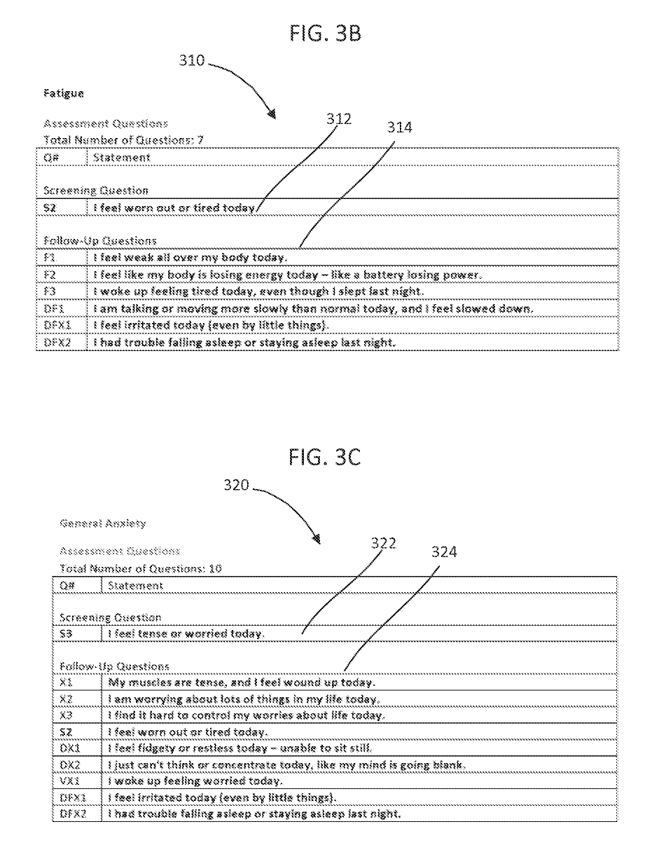

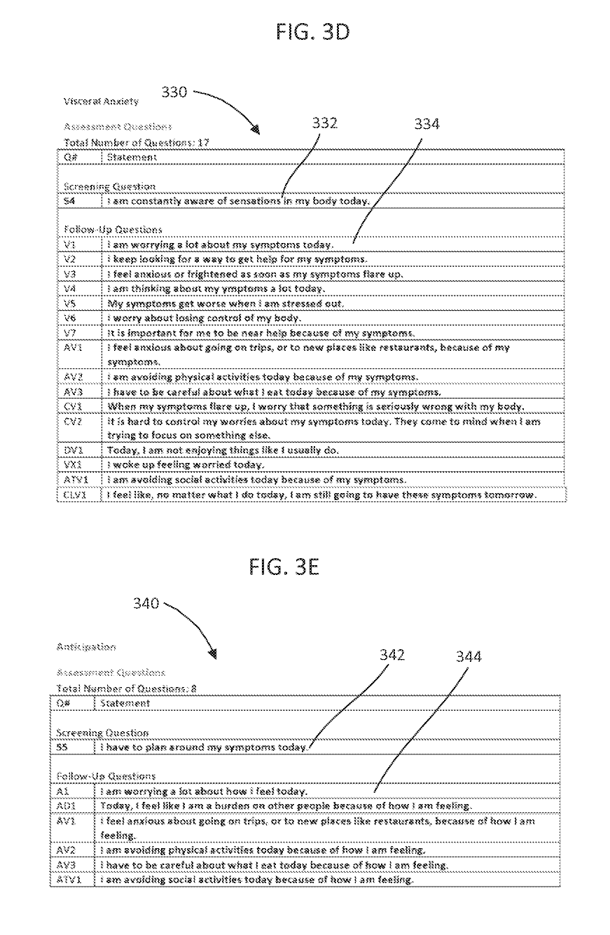

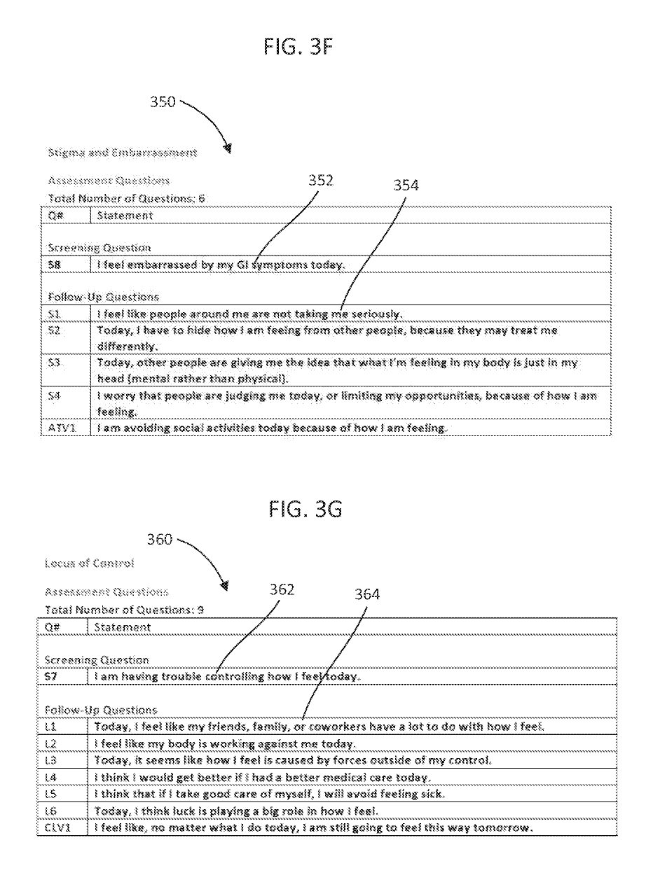

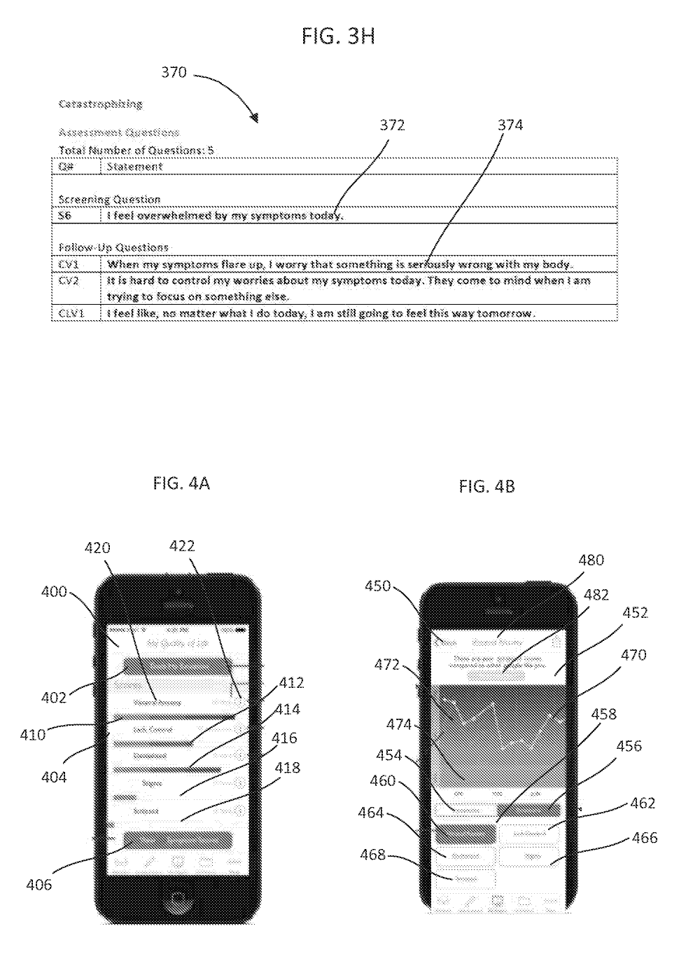

FIGS. 3A-3H show a detailed example of a sample questionnaire flow for a daily assessment made by the program run by the controller 114. The questionnaire is scored by the controller 114 to determine a score reflecting the quality of life of the driver. The scores will cover multiple bio-psycho-social domains, including, but not limited to, physical symptoms (e.g., pain, fatigue, physical function), generalized anxiety, anticipation, depression, stigma/embarrassment, lack of control, catastrophizing, sleep quality, and social support.

FIGS. 3A-3H are scripts that are an example daily assessment questionnaire sequence for scoring. The questions for each domain are divided into screening questions and follow-up questions. Some questions are found in multiple domains, and these will only be asked once per assessment administration. Questions are categorized according to their weighting across one or more domains. The following nomenclature is used to identify domains in this example.

### S—Screening

### A—Anticipation

### C—Catastrophizing

### D—Depression

### F—Fatigue

### L—Locus of Control

### T—Stigma

### V—Visceral Anxiety

### X—General Anxiety

Questions covering multiple domains have a prefix with multiple letters in FIG. 3A-3H. Questions in FIGS. 3A-3H may be presented in random order on each administration of a questionnaire program by the controller 114, but must be presented in a pre-determined domain order to allow the question administration to proceed correctly (i.e., no questions are asked twice, even if they count in multiple domains). The driver is presented with general questions on each administration of the questionnaire program. The instructions are preferably verbally broadcast via the speakers 120 of the audio system in the automobile 110. For example, instructions could be “Please listen to each of the following statements, and say ‘yes’ for any that describe you today. If you do not think a statement describes you, then say ‘no.’” In the welcome message, drivers are prompted with three statements that are available by verbal cue: “I am feeling good today”; “I am not feeling so good today”; and “I have nothing to report today.”

The questions on all of the following screens in FIG. 3A-3H each have scores that are calculated for each domain. The scores are calculated as long as a driver selects the “I am not feeling so good today” option on the initial question page. The total score for a domain will be the total number of items selected divided by the total number of items in a domain. Scores will be reported for every third administration of the questionnaire program, so each reported domain score will be composed of the number of items selected over three administrations/possible number of items in each domain times three. If a patient selects “I am feeling good today” on the welcome screen, scores of 0 will be assigned for each domain. If a patient selects “I have nothing to report today,” then the administration does not count, and the denominator of the score calculation is not advanced.

FIG. 3A shows a depression question page 300 that has an initial screening question 302 with a number of follow up questions 304. As explained above, each of the follow up questions 304 are coded by their domain classification. For example, question DFX1 is found in the depression, fatigue, and general anxiety domains. The exception to this nomenclature is the question S2, which is the screening question for fatigue. This question is always asked, but contributes to the scores of the depression, fatigue, and general anxiety domains.

In this example, the momentary assessments are administered using a standard 0 to 10 analog scale. For example, the system may provide a question in the format such as: “On a scale from zero, meaning worst possible, and ten, meaning best possible, how are you feeling right now?” In this example, the daily check-ins will be administered with a sequence of binary (yes/no) responses categorized in a taxonomy that maps to bio-psycho-social domains as shown in FIGS. 3A-3H.

FIG. 3B shows an example fatigue question page 310 that includes an initial screening question 312 with a number of follow-up questions 314. FIG. 3C shows an example general anxiety question page 320 that includes an initial screening question 322 with a number of follow-up questions 324. FIG. 3D shows an example visceral anxiety question page 330 that includes an initial screening question 332 with a number of follow-up questions 334. FIG. 3E shows an example anticipation question page 340 that includes an initial screening question 342 with a number of follow-up questions 344. FIG. 3F shows an example catastrophizing question page 350 that includes an initial screening question 352 with a number of follow-up questions 354. FIG. 3G shows an example locus of control question page 360 that includes an initial screening question 362 with a number of follow-up questions 364. FIG. 3H shows an example stigma and embarrassment question page 370 that includes an initial screening question 372 with a number of follow-up questions 374.

In this example, the system 100 in FIG. 1 is scheduled to present a weekly questionnaire to a driver but other intervals such as daily, bi-weekly, or monthly may be used. The weekly questionnaires in this example employ NIH PROMIS scales comprised of multiple-choice questions and use computerized adaptive testing (CAT) and item response theory (IRT) for scoring. IRT is referred to as “modern psychometric theory,” in contrast to “classic test theory,” or CTT. The basic idea behind both IRT and CTT is that there is some latent construct, or “trait,” underlying a person's quality of life experience. This construct cannot be directly measured, but can be indirectly measured by creating items that are scaled and scored. For example, “fatigue,” “pain,” or “happiness” are latent constructs as there is no picture of these constructs, but they exist. People can experience more or less of these quality of life constructs, which may be measured along a continuous scale. The amount of a latent construct may be inferred by measuring it indirectly with individual questionnaire items. These items, in turn, may be rolled into scores using a variety of algorithms based on CAT and IRT parameters.

Although both IRT and CTT assume the presence of an underlying, unobservable, latent trait, the techniques diverge when it comes to how the trait is measured. The main difference between IRT and CTT is that the former can support computerized adaptive testing, whereas the latter does not. The example system 100 in FIG. 1 uses IRT and CAT via voice command of publically available PROMIS questionnaires. Of course other appropriate questionnaires in an appropriate taxonomy may be translated into audio cues and used by the system 100.

In a computerized adaptive testing administered item bank for the quality of life assessment system 100, all drivers answer the same initial item. For example, the initial item for a fatigue questionnaire may be “In the past seven days, how often did you have to push yourself to get things done because of your fatigue?” Answers would be: “never,” “rarely,” “sometimes,” “often,” and “always.” However, depending on the driver's answer to the first item, the controller 114 selects a tailored second item such as the question sequence in FIG. 3A. Thus, the system 100 adapts based on the respondent's input to the first item or items. This process continues, based on an underlying PROMIS algorithm, until the controller 114 is satisfied that it has a good sense of the amount of some underlying construct (e.g., fatigue). The controller 114 may determine the underlying construct, and the driver may typically answer far fewer questions than would be necessary with CTT, in which a full questionnaire is administered from start to finish and the score is based off the full set of items.

The CAT questionnaires require an underlying IRT algorithm in this example. Whereas a classic test theory question may ask, “Given a person's total score on a questionnaire, what is the respondent's level on the trait being measured?” the IRT may ask: “Given what is known about the unique set of items viewed and individual responses to those items, what is the respondent's most likely level of the trait being measured.” Thus, while classic test theory uses total scores based on all items, the IRT process deals with individual item responses. Furthermore, the IRT process employs those responses to estimate a likely score without having to use all the items in the full questionnaire.

The mathematics of IRT are complex, but the basic idea is that IRT assumes there is a natural order of difficulty of items in an item bank. There is not difficulty in the usual sense, like one examination question being “harder” than another. Here, difficulty refers to the likelihood of reaching a certain level of quality of life severity. For example, walking 10 feet is less difficult than walking 10 miles—those have an obvious order. The idea of IRT is that items can be rank-ordered along a continuum of difficulty.

In order for IRT to function, each item is assigned a variety of parameters. One parameter, already discussed above, is the difficulty of the item. Another important concept is the item discrimination that models the rate of increase in the probability of endorsing an item as the amount of underlying trait increases. The discrimination factor indicates the strength of association between an individual item and the overall trait being measured. Highly discriminating items can reliably identify patients with small but measurable differences in a trait along a continuum.

Using the difficulty and discrimination parameters of items in the PROMIS questionnaires, CAT may pick and choose items that a driver answers, and quickly hone in on a trait-level estimate. With just a few steps, the IRT algorithm can employ CAT to predict, with a high degree of accuracy, what the driver would have scored had they completed an entire questionnaire. This efficiency allows drivers to quickly score their quality of life via the controller 114. The system 100 may use existing NIH PROMIS algorithms, which are adapted to voice commands received from the microphone 124 that may be processed by the interface module 116 in the automobile 110. Thus, the system 100 in the automobile 110 represents a novel mode and location for use of PROMIS IRT and CAT algorithms for quality of life measurement.

As seen in FIG. 2, after completion of the quality of life assessments, the program run by the controller 114 will score the quality of life questionnaires using algorithms, including publically available (e.g., PROMIS) and unique (e.g., momentary assessment and daily assessment) algorithms. These scores will be stored and available in several locations. First, they will be available to hear through the speakers 120 of the automobile 110 upon request by the driver. Second, the scores may be available through a computer console or display in the dashboard of the automobile 110. Third, the scores may be available through an accompanying mobile health application run by the handheld device 130 or a computing device 160 in FIG. 1.

FIGS. 4A and 4B show interface screens for the handheld device that shows the quality of life questionnaire responses. Of course similar interface screens may be displayed on other computing devices that may be connected to the network 140 in FIG. 1. These visualizations may also be available through the car dashboard console or by voice command through a verbal overview of the scores. A “heatmap” visualization for both cross-sectional and longitudinal quality of life scores may be presented as shown in FIG. 4B. FIG. 4A shows a results screen 400 for sample results of daily assessment for anxiety, lack of control, devitalizaton, stigma, and stress. The results screen 400 includes a “track my emotions” button 402, a scores screen 404, and a view symptom scores button 406. Selecting the “track my emotions” button 402 results in display of data relating to emotions. For example, the display might show a bar chart tracking changes in QoL scores over time, or a “heatmap” color chart shading the intensity of emotions. Selecting the view symptom scores button 406 results in display of information relating changes in QoL. The scores screen 404 includes a visceral anxiety bar 410, a lack control bar 412, a devitalized bar 414, a stigma bar 416, and a stressed bar 418. Each of the bars 410-418 are color coded and include a description 420 which gives a description of the person's quality of life in each of the symptoms. The bars 410-418 give a physical and color indication of how high the user's score is in each of the emotions. In this example, the higher scores indicate emotions are running higher. The bars 410-418 also include an information icon 422 that allows a user to open a window with a description of the symptom.

FIG. 4B shows an example assessment screen 450 for a breakout of anxiety longitudinally tracked over time. The screen 450 includes a chart area 452, a symptoms button 454, an emotions button 456, and a number of selection buttons field 458. The user may select either symptom data or emotion data based on the symptoms button 454 or the emotions buttons 456. Selecting either will display selection buttons in the selection field 458 related to traits of either symptoms or emotions and display an appropriate chart of the responses relating to the selected trait in the chart area 452. For example, selecting the emotions button 456 displays five separate buttons of emotions in the selection buttons field 458 including a visceral anxiety button 460, a lack control button 462, a devitalized button 464, a stigma button 466, and a stressed button 468. Selecting any of the buttons 460-468 results in a specific chart that shows scores over time in the chart area 452.

In this example, the user has selected the emotions button 456 and the visceral anxiety button 460. A plot line 470 is displayed that shows the score of the user relating to visceral anxiety over a certain time period such as three months. The chart area 452 may have a heat map coding, where the higher scores are in a red shaded area 472 while the lower scores are in a green shaded area 474. The chart area 452 thus displays the trend of scores, which provides the user with information about their changing QoL over time. A description field 480 is also displayed on the interface 452, which gives a brief description of the selected trait that in this example is visceral anxiety. An information button 482 is displayed that allows a user to display a window with a more detailed explanation on the selected trait.

The system 100 will evaluate the driver's quality of life scores and provide interpretations. These interpretations will vary depending on the type of assessment. For weekly PROMIS scores, the system 100 may prepare a report that describes how the driver compares to other people in the general U.S. population who have completed the same scales. The system 100 will provide this interpretation using percentile scores. For example, if a patient receives a score of 85 on fatigue (range of 0 to 100) over the previous week, then the interpretation might be:
“Your fatigue over the past week was scored on a scale ranging from 0 to 100, where 0 means no fatigue, and 100 means worst possible fatigue. Your score was 85. What that means is your score is very high compared to other people. For every 100 people who complete the fatigue questionnaire, you scored higher than 85 of them. If you have any concerns about the level of your fatigue, you might wish to speak with a health care provider. You may also want to hear more about what causes fatigue and what to do about it. If so, then say ‘hear more’ to start your program.”

For momentary and daily assessments the system will use unique algorithms to score and interpret the results. For example, the system 100 may identify a patient with a psychological trait called “external locus of control” based on the driver's response to the “lack of control” questions in FIG. 3G. The system 100 might offer both verbal (via voice command in the car) and written (via the mobile applications) explanations regarding external locus of control, as follows:
Your answers to the questions indicate that you have something called “external locus of control.” Let's talk about what that means.
Some people feel that, no matter what they do, they will never get any better. They can feel frustrated, sad, or even angry about their lot in life. Other people feel like they have power to change how they react to problems, even though they may still be affected by the ups and down of life.
The term locus of control, which literally means the “location of control,” refers to how much control people think they have over their lives. Some people believe that life is uncontrollable, and nothing can be done to stop bad things like accidents or illnesses. They believe the stars are aligned against them, they've been dealt a bad hand, or that external, uncontrollable forces are making life difficult for them. These people are said to have an external locus of control.
Other people believe they can change their circumstances if they dig deep, and respond positively and constructively to life's challenges. They believe they have the power to change their mind, or influence others to make their own lives better. These people are said to have an internal locus of control, meaning they believe their destiny is controlled from within.
Imagine you are a student getting results back from a test. If you think your grade is a reflection of your ability and preparation (that is, how well you studied, listened, and performed), then you are showing an internal locus of control. On the other hand, if you think your grade is a reflection of the teacher's ability to instruct and test you, then you are showing an external locus of control. The same person may change their opinion about this depending on the situation. When people do well, they tend to attribute the success to themselves (internal); when they do poorly, they tend to blame others for their poor performance (external).
Having an external locus of control can make symptoms like pain, fatigue, or other bodily aches more difficult to handle. If you think your symptoms are from bad luck, that they haven't gotten any better because other people are not able to figure it out, and that things like medications or other therapies don't work, then you are showing an external locus of control for your symptoms. Instead, if you thing that something like stress is contributing to your symptoms, and you believe that if you continue to work with others that you will start to feel better, then you are showing an internal locus of control.
In reality, people are rarely at either of these extremes, and instead fall somewhere in between. On some days you may feel little control, and on others you may feel like taking full control of your GI symptoms. Going back and forth is normal. At this point, do not focus on being “right or wrong.” Instead, focus on how to change locus of control and improve your quality of life.
Researchers have found that patients who don't always feel well can help control their feelings by internalizing their locus of control. By focusing on things you can control, you may find that it helps you better manage your symptoms and gain control over your life. For example, you might want to eat healthier foods, exercise more, or get more sleep. The system offers more advice about how to achieve these goals through guided coaching and recommended self-improvement exercises. If you want to learn more about what the system can offer, you can visit the toolbox. Just say “toolbox” to get a list of all the offerings. The toolbox will also provide a list of tailored learning modules just for you, based on your answers to the questions.

Similar descriptions will be available for a wide variety of other bio-psycho-social states and traits. In each case, the system will evaluate the momentary, daily, and weekly scores; interpret the results; map them to a specific set of quality of life constructs; and provide lay language explanations of those constructs.

The system 100 will feature a personalized coaching environment in the form of the toolbox module 158 in FIG. 1. The toolbox module 158 houses a variety of educational applications covering a wide range of behavioral interventions to educate about quality of life constructs and improve quality of life. The system 100 will provide a list of suggested improvement modules based on the driver's quality of life assessment scores. The list of improvement modules may be presented through the console on the automobile 110, the portable device 130, the computing device 160, or any web-enabled device that may communicate with the server 150. For example, patients with stress and anxiety will learn about mindful medication and stress management techniques. Another example may be in-car modules that will include exercises and instructions that may be transmitted verbally and do not interfere with driving but allow users to think deeply about their quality of life and how to improve it while safely operating the car. Such modules may be downloaded to the controller 114 from the server 150 via the Internet 140. The modules may be made available on installation of the controller 114. Variations may include changes in ambient lighting and music in the automobile 110 to safely enhance the environment. Additional in-depth exercises, such as guided hypnosis, meditation, or controlled breathing exercises, may be offered through the mobile application for use outside of the automobile on the handheld device 130 or the computing device 160 when it is safe to do so. In addition to recommended modules, the toolbox module 156 will offer answers to specific behavioral or cognitive goals, including, but not limited to: “I want to learn how to think more positively”; “I want to learn how to live with symptoms and feelings without being dragged down by them”; “I want to learn how to use mindful meditation to relax”; and “I want to learn more about how my mind and body are connected.”

Other modules may be employed in the toolbox module 156 including talk therapy, cognitive exercises, and links to third-party applications to address areas of psycho-social concern.

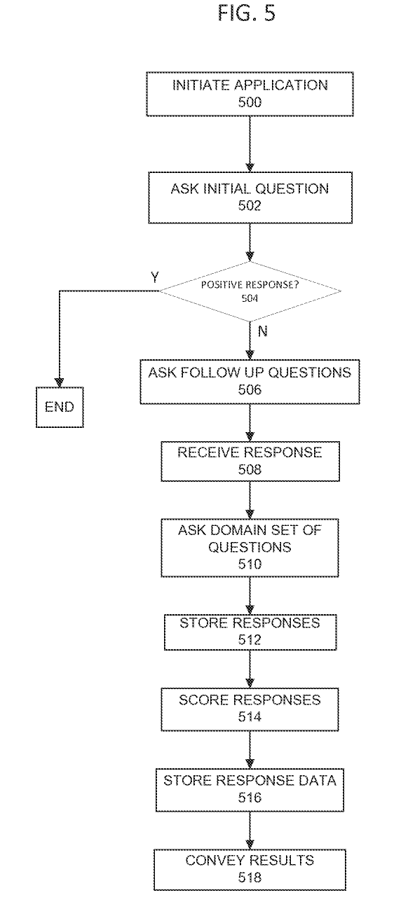

The process of gathering quality of life data in a vehicle will now be described with reference to FIGS. 1-4 in conjunction with the flow diagram shown in FIG. 5. The flow diagram in FIG. 5 is representative of example machine readable instructions for gathering quality of life data for the system 100 in FIG. 1. In this example, the machine readable instructions comprise an algorithm for execution by: (a) a processor, (b) a controller, and/or (c) one or more other suitable processing device(s). The algorithm may be embodied in software stored on tangible media such as, for example, a flash memory, a CD-ROM, a floppy disk, a hard drive, a digital video (versatile) disk (DVD), or other memory devices, but persons of ordinary skill in the art will readily appreciate that the entire algorithm and/or parts thereof could alternatively be executed by a device other than a processor and/or embodied in firmware or dedicated hardware in a well-known manner (e.g., it may be implemented by an application specific integrated circuit (ASIC), a programmable logic device (PLD), a field programmable logic device (FPLD), a field programmable gate array (FPGA), discrete logic, etc.). For example, any or all of the components of the interfaces could be implemented by software, hardware, and/or firmware. Also, some or all of the machine readable instructions represented by the flowchart of FIG. 5 may be implemented manually. Further, although the example algorithm is described with reference to the flowcharts illustrated in FIG. 5, persons of ordinary skill in the art will readily appreciate that many other methods of implementing the example machine readable instructions may alternatively be used. For example, the order of execution of the blocks may be changed, and/or some of the blocks described may be changed, eliminated, or combined.

The quality of life data gathering process is initiated by the controller 114 in the automobile 110 for the driver or other occupant (500). The questionnaire program may be initiated automatically or the user may activate the program. An initial question is accessed in relation to the current quality of life (502). The answer is received and if the answer is positive, the program is ended (504). If the answer is negative, the program asks follow up questions (506). The response is received from the follow up questions (508). Sets of questions are asked in different domains based on the response to the follow-up questions (510).

The responses are stored by the controller 114 (512). The responses are then scored by the controller 114 (514). The resulting data is sent via the communication interface 126 to the central database 152 for storage in relation to historical data relating to the user (516). As explained above, the data may be evaluated or used to recommend further action in the form of self-improvement applications in the toolbox. The evaluation of the data may then be conveyed to the user via vocal output in the automobile 110, on a visual display in the automobile, or in a mobile device (518).

Various embodiments of the invention are described above in the Detailed Description. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventors that the words and phrases in the specification and claims be given the ordinary and accustomed meanings to those of ordinary skill in the applicable art(s).

The foregoing description of various examples known to the applicant at this time of filing the application has been presented and is intended for the purposes of illustration and description. The present description is not intended to be exhaustive nor limit the invention to the precise form disclosed and many modifications and variations are possible in the light of the above teachings. The examples described serve to explain the principles of the invention and its practical application and to enable others skilled in the art to utilize the invention in various examples and with various modifications as are suited to the particular use contemplated. Therefore, it is intended that the invention not be limited to the particular embodiments disclosed for carrying out the invention.

While particular examples of the present invention have been shown and described, it will be obvious to those skilled in the art that, based upon the teachings herein, changes and modifications may be made without departing from this invention and its broader aspects. It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.).

What is claimed is:

1. A system for performing quality of life assessment of a person in a vehicle, the system comprising:
an audio system for broadcasting audio messages;
a microphone for vocal inputs from the person; and
a controller coupled to the audio system and the microphone, the controller operative to:
ask a series of questions relating to quality of life to the driver using the audio system;
receive responses to the questions via the microphone;
translate the responses into quality of life data;
evaluate the quality of life of the person based on the responses to the questions.

2. The system of claim 1, further comprising:
a central database having an interface to receive quality of life data from the controller via a wireless network, the central database including quality of life data from other persons;
a server in communication with the network, the server operative to evaluate quality of life data from the persons in comparison with quality of data from other persons in the central database.

3. The system of claim 2, further comprising a tool box including at least one improvement program for improving quality of life of the driver based on the quality of life data, wherein the controller runs the at least one improvement program on request of the person.

4. The system of claim 2, further comprising a portable device in communication with the network, the portable device receiving the quality of life data and displaying the results of the evaluation of the quality of life data.

5. The system of claim 4, wherein the portable device displays the quality of life data based on the responses to the series of questions answered by the person at predetermined times.

6. The system of claim 4, wherein the controller asks the series of questions at periodic intervals, the data based on the responses to the questions being stored in the central database.

7. The system of claim 1, wherein the questions are grouped in domains that are asked based on the answer to an initial screening question

8. The system of claim 1, wherein the responses to the questions are scored, and wherein the scores are stored for the person.

9. A method of gathering quality of life data for a person in a vehicle, the method comprising:
providing verbal questions relating to quality of life to the person in the vehicle;
receiving responses to the questions from the person via a microphone;
translating the responses to the questions into quality of life data;
determining a score based on the quality of life data for the person; and
sending the score relating to quality of life to a storage device.

10. The method of claim 9, further comprising:
storing the quality of life data to a central database including quality of life data from other persons; and
evaluating the quality of life data from the persons in comparison with quality of data from other persons in the central database via a server.

11. The method of claim 10, further comprising:
providing a tool box including at least one improvement program for improving quality of life of the driver based on the quality of life data; and
running the at least one improvement program on request of the person.

12. The method of claim 10, further comprising:
sending the quality of life data to a portable device via a network; and
displaying the results of the evaluation of the quality of life data.

13. The method of claim 12, wherein the portable device displays the quality of life data based on the responses to the series of questions answered by the person at predetermined times.

14. The method of claim 12, wherein the series of questions are asked at periodic intervals, and the data based on the responses to the questions is stored in the central database.

15. The method of claim 9, wherein the questions are grouped in domains that are asked based on the answer to an initial screening question

16. The method of claim 9, wherein the responses to the questions are scored, and wherein the scores are stored for the person.
